(19) United States
(12) Patent Application Publication
(10) Pub. No.: US 2023/0394995 A1
(43) Pub. Date: Dec. 7, 2023

(54) APPARATUS TO JOINTLY DISPLAY AN ELECTRONIC SHELF LABEL AND INDICIA

(71) Applicant: Carl Pomerantz, Beaconsfield (CA)

(72) Inventor: Carl Pomerantz, Beaconsfield (CA)

(21) Appl. No.: 18/204,228

(22) Filed: May 31, 2023

Related U.S. Application Data
(60) Provisional application No. 63/473,472, filed on Jun. 1, 2022.

(51) Int. Cl. G09F 3/20

(52) U.S. Cl. CPC G09F 3/204; G09F 3/208

(57) ABSTRACT

The present invention discloses a gripper integrated into an Electronic Shelf Label (ESL) store fixture to display indicia jointly with an ESL without obscuring the ESL. Indicia draws a shopper's attention to a promoted product or communicates information to a store's personnel. ESL store fixtures are connected to point of purchase displays, and can either be ESL clips, ESL strips, or ESL protectors. The gripper's fingers, which frictionally hold indicia, are coextruded with the ESL store fixture. The ESL store fixture is made of a hard material such as plastic, and the gripper fingers are made of a softer, rubber-like material. The gripper can be located anywhere on the ESL store fixture, as long as the indicia does not cover the ESL. ESL clips can be attached to shelf edges, peg hooks, wire baskets, floor models, and any other store displays. ESL protectors shield ESLs from impact or disturbance.

This application claims the priority of U.S. Provisional patent application No. 63/473,472, filed on Jun. 1, 2022.

The present invention relates to an apparatus for jointly displaying an Electronic Shelf Label (“ESL”) and indicia in a retail environment. The apparatus permits to conspicuously flag products that a retailer desires to promote to customers, or communicate an internal message to the retailer's employees.

The indicia may be inserted and removed quickly by a retailer's employee, and does not obscure the ESL. The apparatus may also offer other features such as protecting the ESL from damage, dislodgement, and tampering.

### BACKGROUND

In retail, items need to be priced so that shoppers/clients can be made aware of an item's price prior to purchase. Up until the latter part of the twentieth century, most retailers ticketed individual products with pricing labels or stickers. This was a clear way for customers to know a product's price, but was very labor intensive for store personnel to do. It was also very complex to logistically control price changes.

Towards the end of the century, new merchandizing methods were developed so that ticketing individual items with pricing was replaced by placing a label or sticker on the shelf edge or merchandizing peg so that all products behind or above the price ticket (commonly known as a bin ticket) had the ticketed price. This change represented major labor savings for the retailer.

With advancements in technology at the end of the century, it has become possible to replace these formerly paper, cardstock, or stickered price labels, with Electronic Shelf Labels (commonly referred to as “ESLs”). ESLs attach to store fixtures via a host of methods that include extruded strips, clips, segments, and molded parts.

These fixture attachment methods mechanically engage or grip the ESL and retain the ESL in place on the fixture or floor model. Examples include ESL shelf edge strips, basket clips, strips, peghook segments, and other ways that engage the ESL, and then attach this assemblage to store fixtures or floor models.

The ESL units themselves are typically constructed with engaging tabs on their rearward face so that they can mechanically slide or snap into plastic shelf edge strips, and most fixture attachment components feature engaging lips that lock the ESLs onto the strips. The same engaging lips mechanism is used across virtually all fixture attachment profiles of strips, segments, peghooks, and other fixture attachment components. These fixture attachment components can be extruded, molded, or machined.

ESL systems provide significant operational labor savings to the retailer. Among the advantages are that, with traditional paper bin tickets, every time a price change occurs, there is data entry to register the price change, plus new bin tickets have to be printed, sorted, old tickets removed, and new tickets inserted. Labor time involved on average is estimated at several minutes per label price change.

With ESLs, price changes can be wirelessly conducted, can be automatically updated, and changed. Furthermore, the ESL labels themselves can also indicate additional data beyond price, such as inventory information. Accuracy of information is improved. Within seconds, prices can be updated across multiple systems, so pricing can quickly be changed to stay competitive and match the competition. The ESL approach yields improved productivity, price optimization, and price agility.

Further benefits and goals of using ESLs are improved promotional opportunities and better communication with shoppers. For example, if a retailer has items that they want to feature for Sale or Clearance, they can centrally alter all pricing for these items. Some ESLs further allow the face of the tag itself to change color and add electronic graphics in an attempt to signal, differentiate, and highlight these specials to customers more persuasively.

A shortcoming of this system is that digital highlighting of the tag's screen is often not conspicuous enough to sufficiently flag and alert a shopper to the item's Special or altered status. Although the driving force behind justifying the high initial capital cost of switching from paper pricing labels to an ESL system is a significant reduction in labor costs, a novel and rapid method is needed for a retailer to conspicuously add a supplementary flag to the ESL of a featured item in a cost-effective way while ensuring that store labor costs are kept to a minimum.

There is currently an unaddressed need to amplify an ESL's performance to draw attention to certain products, and the current invention solves this problem by adding a visual stimulus via indicia to the ESL.

For conventional paper label shelf strips/fixture attachment components, various clips, adhesive shelf talkers and tags, engageable sign holder sleeves, or tape and the like, can be used to hold this added signage in place. Some strip designs include a self-contained front gripper portion on their window, such as depicted in U.S. Pat. Nos. 6,266,906, 6,708,436 and 8,613,156.

Shelf strips that feature this self-contained front gripper portion are therefore more readily suited to quickly and efficiently accommodate placement and removal of shelf talkers, flags and the like, as no additional parts or adhesives are needed to hold this signage in place. However, prior art with integrated grippers only discloses configurations wherein any indicia placed into the grippers will block or obscure the original price label.

U.S. Pat. No. 4,557,064 discloses a gripper with coextruded projections for holding a card in conjunction with a paper price label. However, once a card is inserted into the gripper, the paper price label is obscured.

There is also known U.S. Pat. No. 6,553,702 describing an ESL bracket with an integrated clip adapted for selective attachment of advertising or other materials. However, this clip is made of the same material as the ESL bracket, and its ability to hold a card is reduced because it does not offer as much friction holding force as a softer material. In contrast, the gripper fingers of the present invention are made or coated with a softer, rubber-like material that is coextruded alongside the ESL fixture attachment components, and far better suited to firmly hold cards and other indicia due to the softer material's superior ability to use friction force.

The current invention is an addition of at least one coextruded gripper finger to all prior art ESL fixture attachment components that allow the retailer to flag, and then to ultimately unflag, desired items in a labor-efficient fashion. The invention has features such that the message can be mounted (and detached) rapidly with one hand, for optimum speed or placement, without blocking the ESL display.

In one embodiment, the signage gripper is made as an integral part of the ESL fixture attachment component. The gripper can be integrated along the fixture attachment component's length so that indicia such as a card can be engaged and displayed generally below, above, or beside the ESL. The gripper can be manufactured such that indicia is displayed at a fixed angle, parallel to the ESL's face, or at any predetermined and desired angle. The joint between the ESL fixture attachment component and the gripper can be solid or hinged. The detailed position of the gripper can also be such that it is somewhat rearward or forward relative to the ESL.

In another embodiment, the gripper can be a separate component that engages into, or adheres onto the fixture attachment component. A typical example that illustrates the invention's unique benefits would be if a retailer wishes to flag all Sale items for a weekly Sales special. Ideally before store opening, the retailer can centrally alter the ESL pricing on all items to be on Sale. Then, with a push of one button, they can have all Sale items' ESLs flash. An employee can then rapidly tour the store, and quickly insert indicia with a “Sale” sign on all flashing ESLs.

Flashing of ESLs is turned off when all “Sale” ESLs have been flagged. In a similar fashion, at the end of the sales event period, ESLs for items on sale can be made to flash, and “Sale” indicia can be quickly removed.

The invention can be made of materials suited for extreme environments, such as store freezers and the like.

Another advantage of this invention is that ESLs come in various sizes, but often share the same rear inner top and bottom edge dimensions, so that one size of the invention can be compatible with several sizes of ESLs.

In addition to using the invention to promote sales events, it can also be employed to quickly and firmly flag or label other information desired, such as internal inventory information like stock outs, or any other information to be conspicuously communicated with customers or employees.

In addition to ESL fixture attachment components, in rougher high traffic environments, ESLs can be prone to disturbance, dislodgement, and breakage. As a result, retailers employ a host of impact resistant protectors to shield ESLs against impact. Protectors are transparent plastic, often extruded. In other embodiments of this invention, these protectors can include a gripper so positioned that indicia such as a card can be inserted and displayed to highlight an ESL's message.

### BRIEF DESCRIPTION OF THE DRAWINGS

FIG. 1 shows a perspective view of a prior art ESL store fixture attachment component for affixing an ESL to a retail shelf edge.

FIG. 2 shows a perspective view of the first embodiment of the present invention, namely an ESL store fixture attachment component for affixing an ESL to a retail shelf edge with an integrated gripper.

FIG. 3 shows a front view of FIG. 2 with an ESL.

FIG. 4 is a side view of FIG. 2.

FIG. 5 shows a side view of FIG. 2 with indicia in the gripper.

FIG. 6 is a front view of FIG. 2 attached to the front edge of a shelf, with an ESL and indicia in the gripper.

FIG. 7 shows a side view of a variant of the first embodiment attached to a shelf edge, with a gripper above the ESL-engaging portion.

FIG. 8 is a perspective view of FIG. 7, with indicia in the gripper.

FIG. 9 shows a side view of another variant of the first embodiment, with a gripper below and behind the ESL-engaging portion.

FIG. 10 is a front view of FIG. 9 attached to a shelf edge, with indicia in the gripper.

FIG. 11 shows a perspective view of the second embodiment of the present invention, namely an ESL shield for retail shelving.

FIG. 12 is a side view of FIG. 11.

FIG. 13 shows a perspective view of the second embodiment protecting an ESL on a retail shelf.

FIG. 14 is a front view of FIG. 13.

FIG. 15 shows a perspective view of the third embodiment of the present invention, namely an ESL casing for an ESL mounted on wire rack.

FIG. 16 is a side view of FIG. 15.

FIG. 17 shows a front view of FIG. 15 with an ESL and indicia in the gripper.

FIG. 18 shows a perspective view of a variant of the third embodiment with a gripper below the ESL.

FIG. 19 is a side view of FIG. 18.

FIG. 20 shows a perspective view of FIG. 15 in use on a wire rack, with an ESL, and indicia in the gripper.

FIG. 21 shows the apparatus seen on FIG. 7, with a wire-engaging clip, attached to a peg hook cross-brace.

FIG. 22 shows the apparatus seen on FIG. 26 attached to a peg hook's flat mount via adhesive.

FIG. 23 demonstrates the apparatus seen on FIG. 26 glued to a backing card, which is attached to a floor model bicycle handlebar.

FIG. 24 shows a fourth embodiment of the present invention, being a free-standing ESL display with an ESL.

FIG. 25 shows a prior art ESL store fixture attachment component for affixing an ESL to a flat surface via an adhesive.

FIG. 26 shows another variant of the first embodiment, being an ESL store fixture attachment component for affixing an ESL to a flat surface via an adhesive.

FIG. 27 demonstrates the invention seen on FIG. 26, glued to a shelf edge.

FIG. 28 shows a prior art of an ESL store fixture attachment component for affixing an ESL to a wire basket.

FIG. 29 shows the apparatus of FIG. 21 attached to a wire basket.

FIG. 30 shows a prior art of a protecting sleeve that is slid onto an ESL.

FIG. 31 shows the prior art of FIG. 30 being slid onto an ESL.

FIG. 32 shows a fifth embodiment of the present invention, being an improvement over prior art shown on FIGS. 30 and 31, with an integrated gripper.

### DETAILED DESCRIPTION OF THE DRAWINGS

The present invention enables a retail store to display indicia such as cards together with an ESL without obscuring the ESL's display. Such indicia can be easily installed and removed by store employees, and increases persuasiveness to purchase promoted products.

Indicia is simply slid between overlapping resilient fingers located in the integrated gripper, and is firmly held in the gripper until removed. A typical gripper's finger can be described as a compliant mechanism that flexes and returns to its original position due to its elastic body deformation.

The key to the invention's functionality is coextrusion: the apparatus is formed from a rigid plastic material, and the gripper fingers, made of a softer rubber-like material, are coextruded onto the interior faces of the gripper simultaneously during the manufacturing process. Another possible method to manufacture the invention is to coextrude a softer rubber-like coating onto the gripper's fingers.

The gripper's fingers must have a higher coefficient of friction than the apparatus. If the apparatus is made of the same softer rubber-like material as the gripper's fingers, it will not firmly hold the ESL, and inversely, if the gripper's fingers are made of the same hard plastic as the apparatus, they will not have enough friction to securely retain indicia.

The rigidity of plastics is measured with a unit called “duro”, measured with a Shore durometer, measured either in A scale (softer materials) or D scale (harder materials). Durometer numbers represent a relative comparison of hardness between different but similar materials that have had their hardness measured using the same durometer scale, device and measurement standard. The higher the duro number, the more rigid the product. In the present invention, every component except for gripper fingers (and sometimes joint between ESL store fixture attachment apparatus and gripper) is made of a rigid plastic measuring between 65D and 90D duro, and gripper fingers are made of a softer, rubber-like plastic measuring between 35A and 60A duro.

A gripper for indicia can be located anywhere in proximity to an ESL, thus enabling a store to increase visibility, appeal, value, and desirability of the product that is being flagged with the indicia.

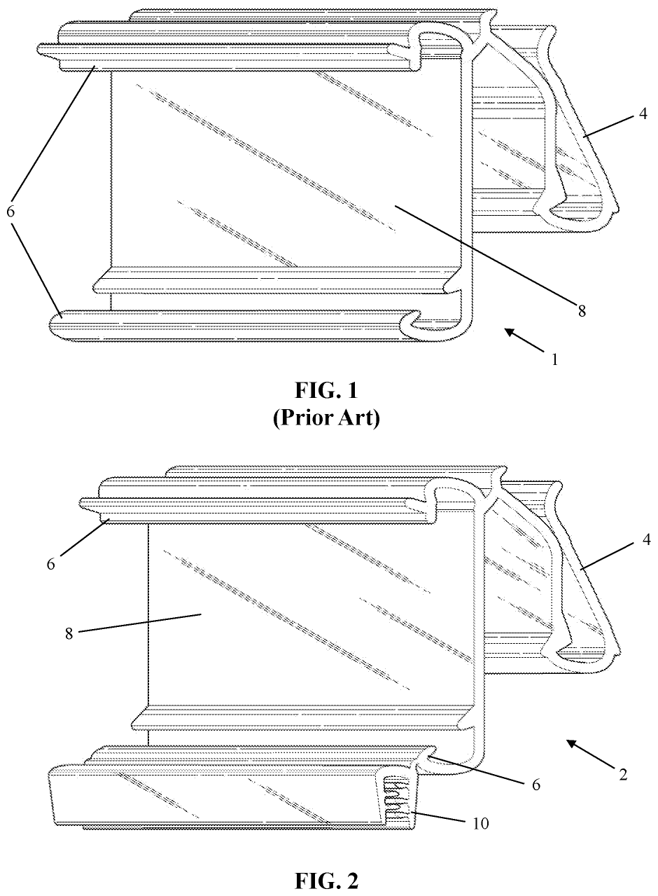

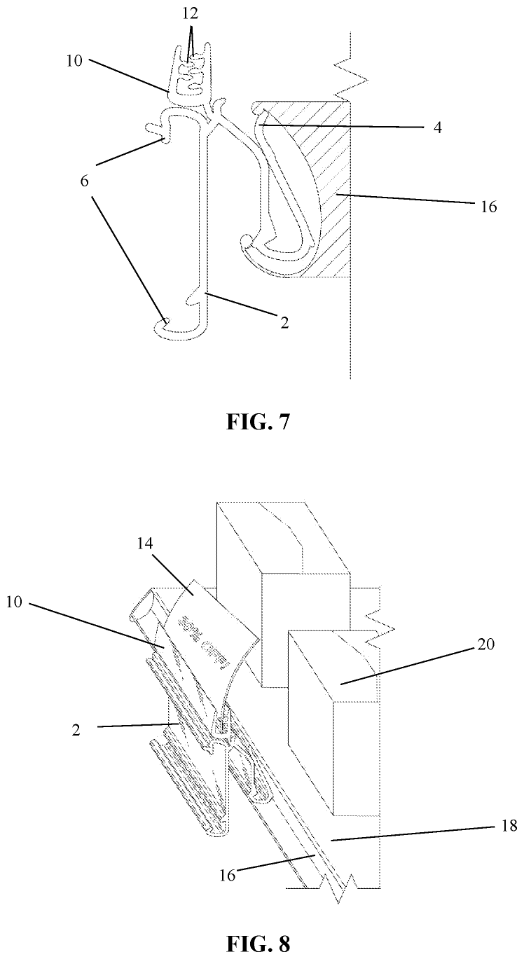

Referring to drawings, FIG. 1 shows a prior art ESL store fixture attachment apparatus 1 (“ESL clip” hereon) for affixing an ESL to a shelf edge 16, comprising shelf-engaging clip 4 that mates to a shelf edge 16 (seen on FIG. 7), with ESL-engaging lips 6 and ESL display socket 8.

ESL clips are essential to a store, and generally have two components: one holds an ESL, and the other attaches the clip to something in the store. The part of the ESL clip that holds the ESL has one job (and it does it well), but the part that is attached to something in the store can vary depending on the application. Thus, there are catalogs of ESL clips for flat horizontal surfaces, flat vertical surfaces, hinged joints, clipped inside 4-foot shelf edge adapters (as in FIG. 7), attached to floor models, wire baskets, and anywhere else the store needs it.

The present invention is an addition to the part of the ESL clip that rarely changes. No matter how and where the ESL clip is attached, a card in the gripper will grab a shopper's attention.

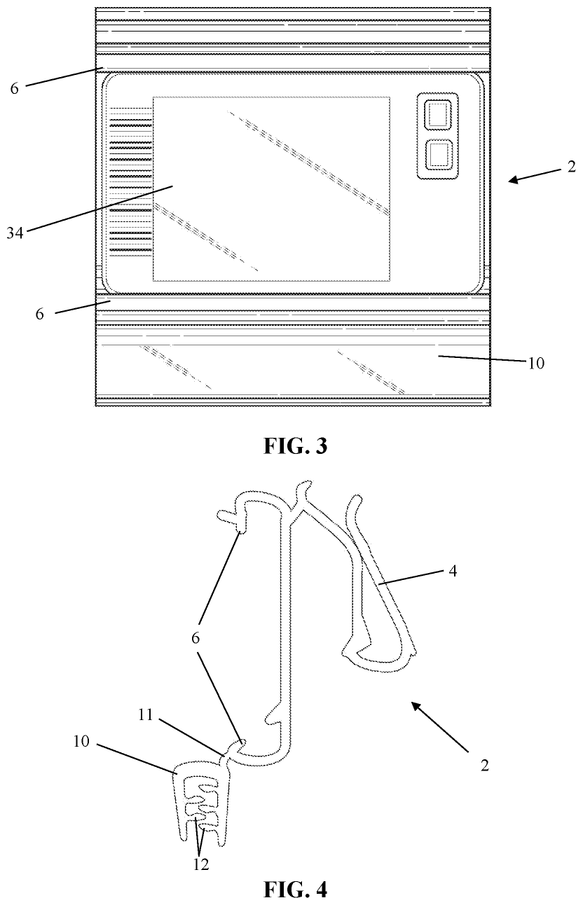

FIG. 2 shows a perspective view of the first preferred embodiment of the present invention for an improved ESL clip 2 comprising a shelf-engaging clip 4 at the rear of apparatus 2, ESL-engaging lips 6, an ESL display socket 8, and a gripper 10 located below lower lip 6. FIG. 3 shows a front view of the invention as seen on FIG. 2 with ESL 34 held in display socket 8 with lips 6.

FIG. 4 is a side view of FIG. 2, showing gripper 10's coextruded fingers 12, fingers 12's tips facing each other, staggered, and overlapping. Gripper 10 is attached to ESL clip 2 by joint 11. Joint 11 can be either made of the same harder plastic as ESL clip 2, or coextruded of the same softer rubber-like material as fingers 12. In the latter, joint 11 will offer a degree of flexibility between ESL clip 2 and gripper 10, thus offering a range of movement for gripper 10 with indicia 14 if bumped or disturbed. FIG. 5 shows the invention seen on FIG. 4 with indicia 14 inserted between fingers 12.

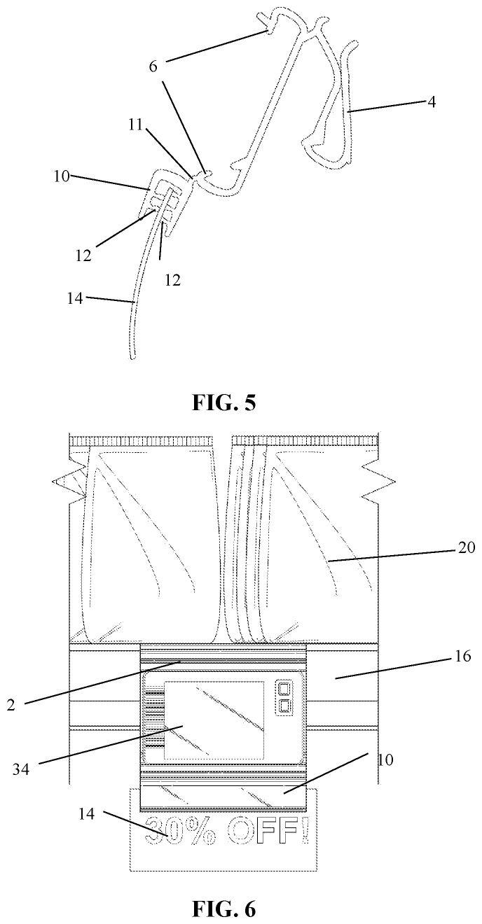

FIG. 6 shows the invention seen on FIG. 2 in use, with apparatus 2 attached to shelf edge 16 holding ESL 34, products 20 displayed behind apparatus 2, and indicia 14 inserted into gripper 10.

FIG. 7 is a side view of a first variant of the first preferred embodiment apparatus 2, wherein shelf-engaging clip 4 is attached to shelf edge 16, and a gripper 10 located above upper lip 6. Shelf edge 16 comprises a C-shaped channel to receive shelf-engaging clip 4. Shelf edge 16 is typically a 4-feet segment, and apparatus 2 can be attached to shelf edge 16 at any point in this segment.

FIG. 8 demonstrates a perspective view of the first variant of the first preferred embodiment in use, with products 20 located behind apparatus 2, and indicia 14 inserted into gripper 10.

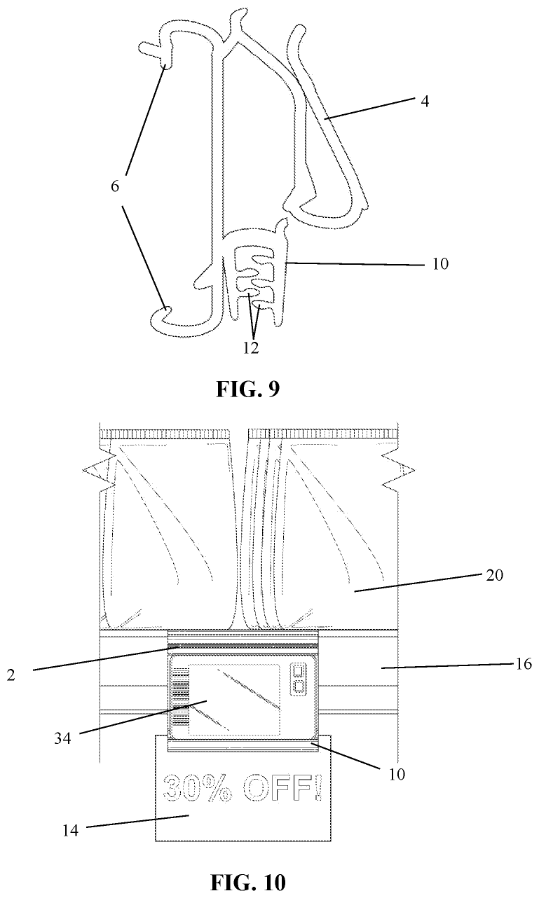

FIG. 9 shows a second variant of the first preferred embodiment, comprising a gripper 10 behind lower lip 6. FIG. 10 shows a front view of the second variant of the first preferred embodiment apparatus 2, with indicia 14 inserted into gripper 10, and products 20 behind apparatus 2.

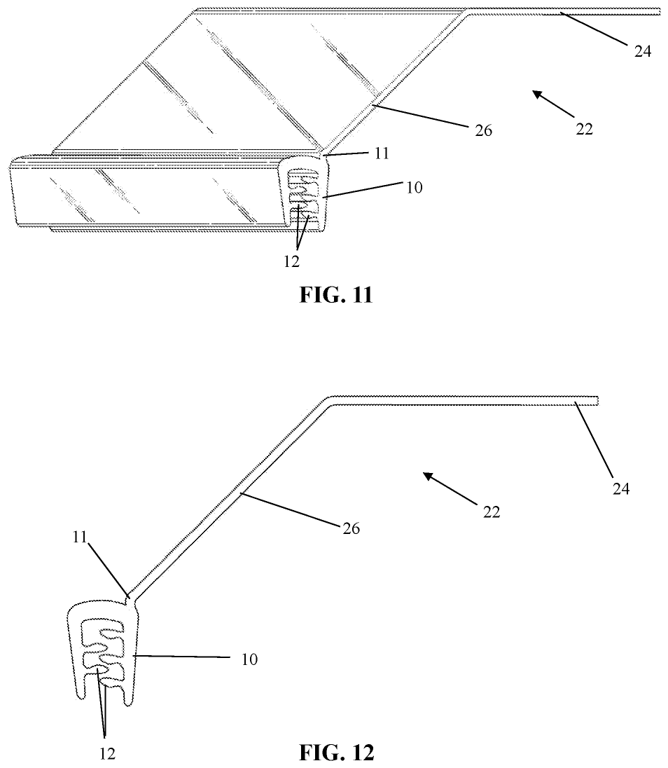

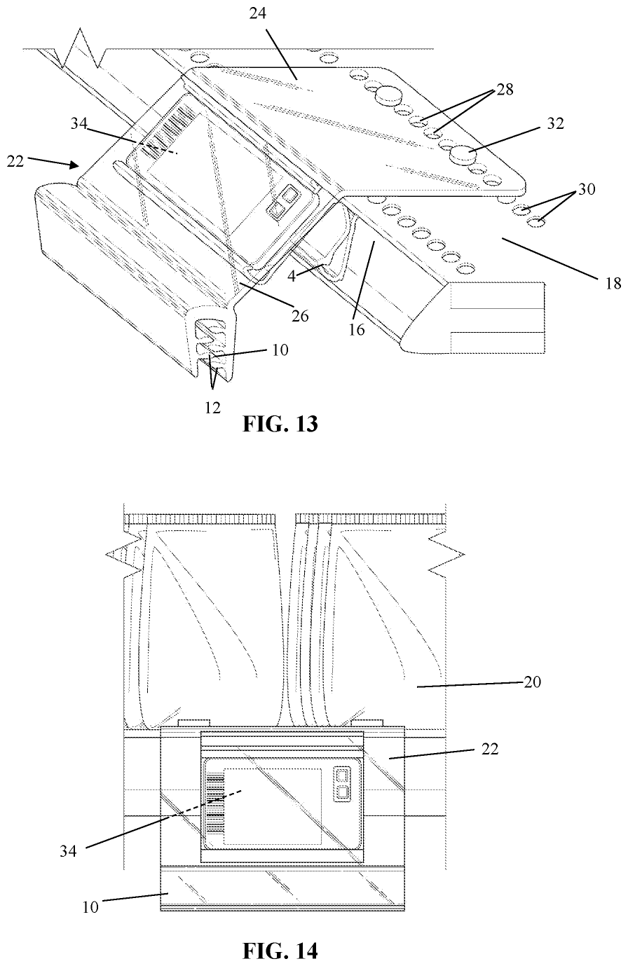

FIG. 11 shows a second preferred embodiment of the present invention, namely a shield 22 for protecting a shelf-mounted ESL. Shield 22 comprises a shelf-engaging portion 24 being coplanar to shelf 18 (seen on FIG. 13), an ESL-covering portion 26 at an angle to shelf-engaging portion 24, and a gripper 10 depending from ESL-covering portion 26 via joint 11. As in FIG. 4, joint 11 can be either made of the same harder plastic as ESL shield 22, or coextruded of the same softer rubber-like material as fingers 12. In the latter, joint 11 will offer a degree of flexibility between ESL shield 22 and gripper 10, thus offering a range of movement for gripper 10 with indicia 14 if bumped or disturbed.

FIG. 12 is a side view of FIG. 11, showing fingers 12 facing each other, staggered and overlapping.

FIG. 13 shows a perspective view of shield 22 protecting ESL 34 engaged in a prior art ESL clip 1 (seen on FIG. 1), which is attached to shelf edge 16 with shelf-engaging clip 4. Shield 22's shelf-engaging portion 24 is attached to shelf 18 by rivets 32 that pass through holes 28 located in shelf-engaging portion 24, and holes 30 in shelf 18. A gripper 10, depending from ESL-covering portion 26, permits installation of indicia 14. Thus, apparatus 22 protects ESL 34 from undesirable disturbance or dislocation by outside forces such as shopping carts.

FIG. 14 is a front view of the invention seen on FIG. 13, with products 20 located behind ESL 34, while being protected by apparatus 22.

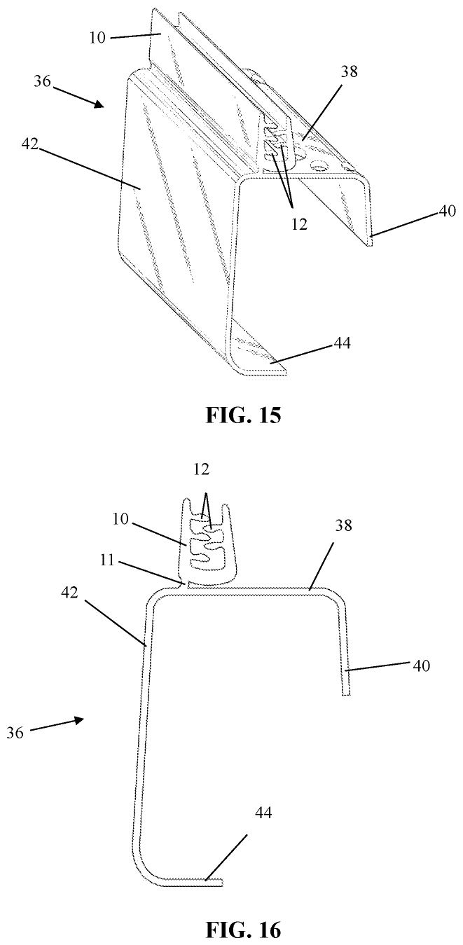

FIG. 15 demonstrates a perspective view of the third preferred embodiment of the present invention, namely casing 36 for protecting a wire-mounted ESL, casing 36 being of a “C”-shaped configuration, comprising a rear lip 40, a top portion 38, a front face 42, and a bottom tongue 44. Gripper 10 is attached to the outside edge of top portion 38, proximal to front face 42.

FIG. 16 shows a side view of the invention seen on FIG. 15. Joint 11 connects gripper 10 to casing 36. Joint 11 can be either made of the same harder plastic as casing 36, or coextruded of the same softer rubber-like material as fingers 12. In the latter, joint 11 will offer a degree of flexibility between casing 36 and gripper 10, thus offering a range of movement for gripper 10 with indicia 14 if bumped or disturbed.

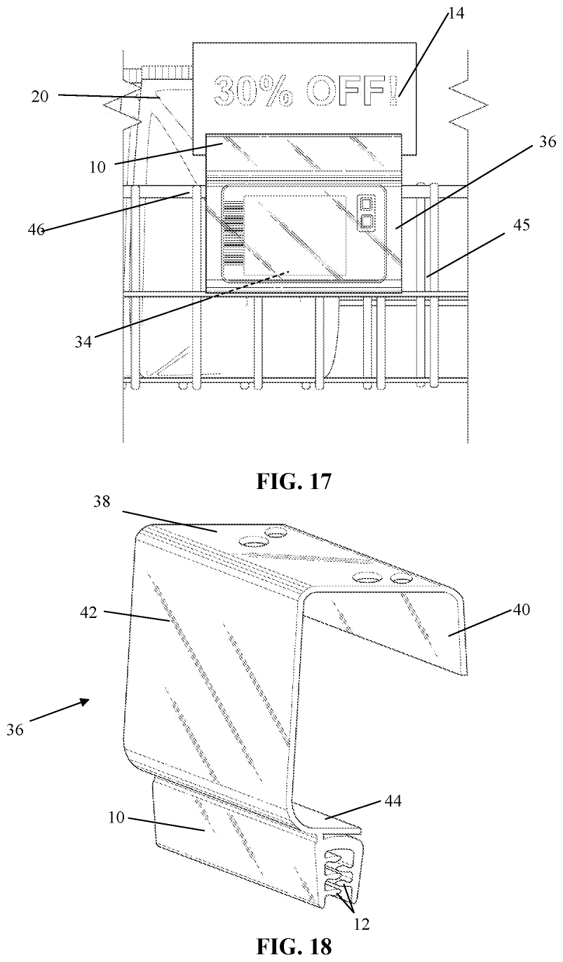

FIG. 17 is a front view of the invention seen on FIG. 15. ESL 34 is mounted on wire 46 of wire basket 45 by fixture attachment component 1 (as shown on FIG. 28). Apparatus 36 is installed over ESL 34, wire 46, and component 1, with indicia 14 inserted into gripper 10. Products 20 appear behind apparatus 36.

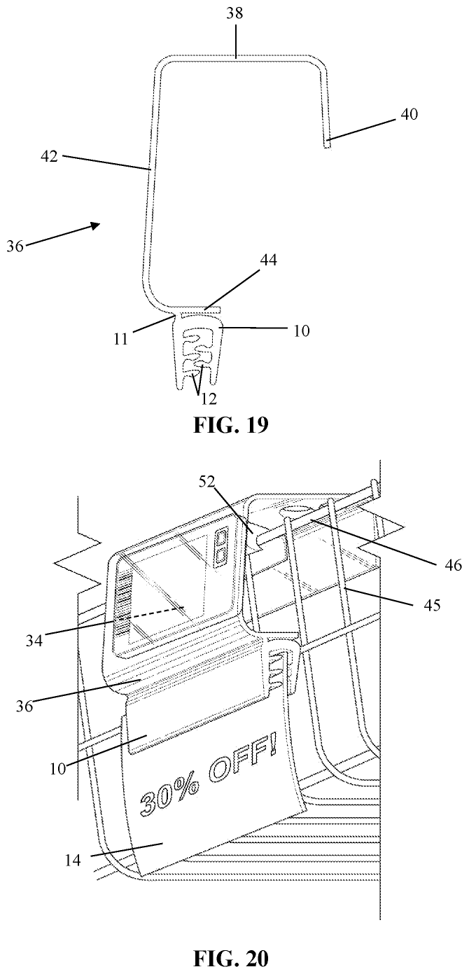

FIG. 18 demonstrates a perspective view of a variant of the third preferred embodiment of the present invention 36, comprising gripper 10 depending below bottom tongue 44. FIG. 19 is a side view of FIG. 18. FIG. 20 shows a perspective view of the variant seen on FIG. 18 in use, with ESL 34 attached to wire 46, apparatus 36 installed onto ESL 34 and wire 46, and indicia 14 inserted into gripper 10.

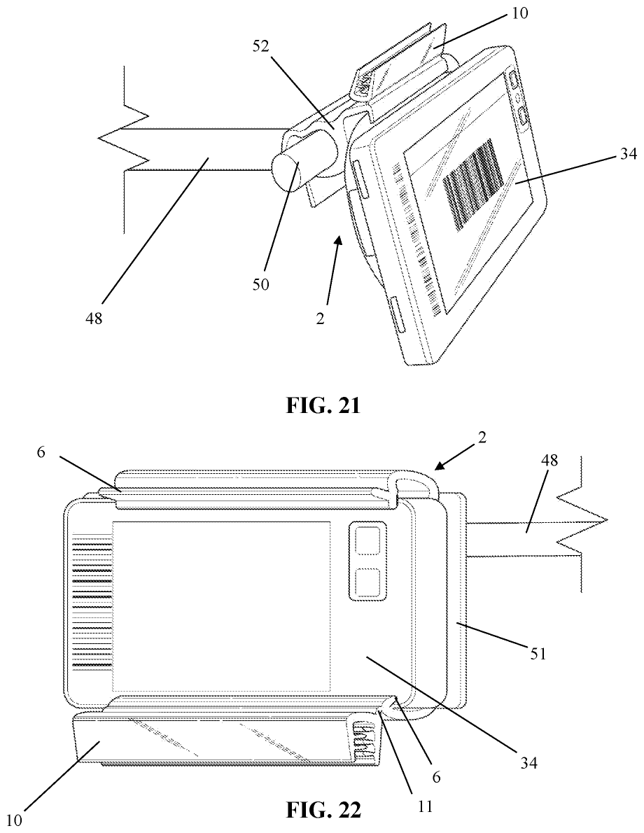

FIG. 21 shows an ESL clip 2 of the present invention attached to a peg hook 48 equipped with a cross-brace 50. ESL clip 2 is attached to cross-brace 50 with a wire-engaging clip 52, and includes gripper 10 above clip 52.

FIG. 21 shows an ESL clip 2 adapted to be glued to a vertical flat surface. In FIG. 21, ESL clip 2 is glued to a flat mount 51 at the tip of a peg hook 48. Gripper 10 is depending from the lower lip 6.

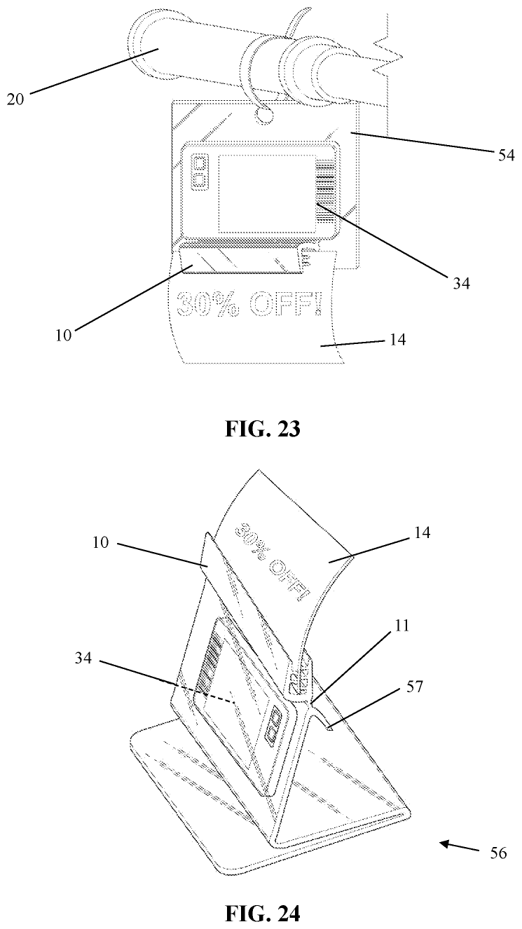

FIG. 23 demonstrates an ESL clip glued to a display card 54, which is attached to a handlebar of a floor model bicycle 20. Display card 54 can be made of a durable material such as cardboard or plexiglass.

FIG. 24 shows a fourth embodiment of the present invention, namely a free-standing ESL display 56, typically made of a transparent plastic. Display 56 comprises a retaining lip 57 that creates a channel for an ESL 34 to be slid into thus immobilizing ESL 34. Gripper 10, attached to ESL display 56 via joint 11, is coextruded with display 56. Joint 11 can be either made of the same harder plastic as ESL display 56, or coextruded of the same softer rubber-like material as fingers 12. In the latter, joint 11 will offer a degree of flexibility between ESL display 56 and gripper 10, thus offering a range of movement for gripper 10 with indicia 14 if bumped or disturbed.

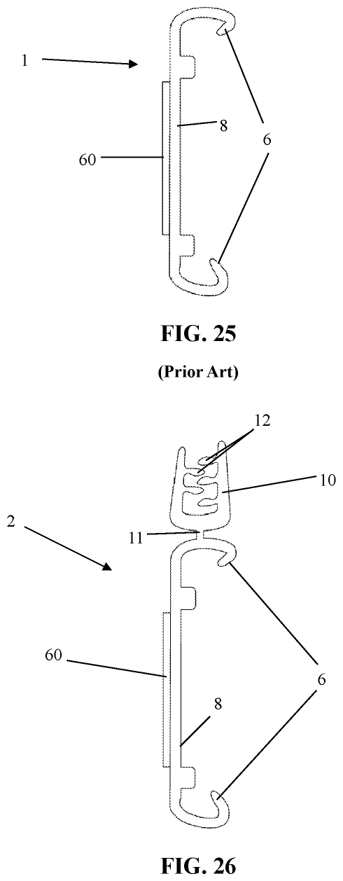

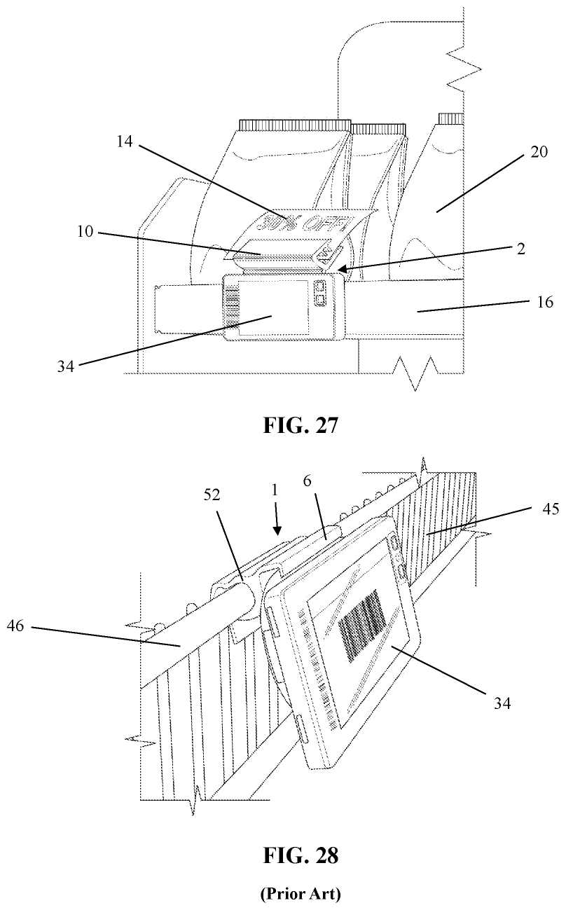

FIG. 25 is a side view of a prior art ESL clip 1 for mounting on a flat vertical surface with adhesive 60. Clip 1 comprises an ESL display socket 8 and lips for retaining ESL 6. FIG. 26 is an inventive improved ESL clip 2 over the ESL clip 1 seen on FIG. 25 with the addition of gripper 10. FIG. 27 demonstrates ESL clip 2 holding ESL 34, glued onto shelf edge 16 with indicia 14 in gripper 10, drawing attention to products 20.

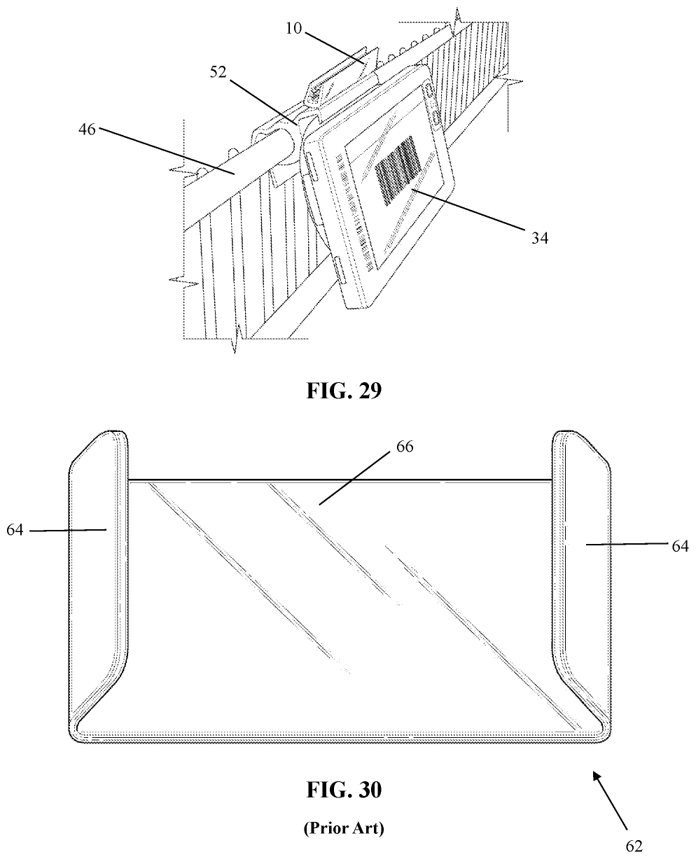

FIG. 28 shows a prior art ESL clip 1 attached to wire 46 of wire basket 45 with wire-engaging clip 52, lips 6 retaining ESL 34. FIG. 29 shows an inventive improved ESL clip 2 over the ESL clip 1 seen on FIG. 28 with the addition of gripper 10.

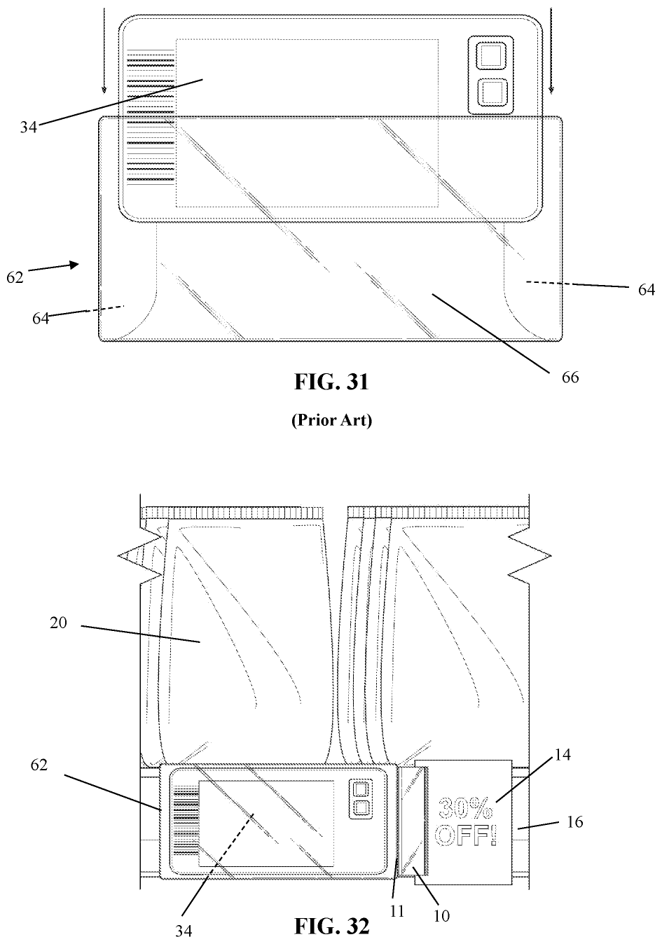

FIG. 30 is a prior art slip-on ESL protector 62 comprising ESL-covering portion 66 and wings 64 that envelop ESL 34 (seen on FIG. 31). FIG. 31 demonstrates insertion of ESL 34 into ESL protector 62, wherein wings 64 abut the sides of ESL 34, thus retaining ESL protector 62 on ESL 34. FIG. 32 demonstrates an improved ESL protector 62 on ESL 34 attached to shelf edge 16 with products 20, with gripper 10 attached to ESL protector 62 via joint 11, gripper 10 holding insignia 14. Joint 11 can be either made of the same harder plastic as ESL protector 62, or coextruded of the same softer rubber-like material as fingers 12. In the latter, joint 11 will offer a degree of flexibility between ESL protector 62 and gripper 10, thus offering a range of movement for gripper 10 with indicia 14 if bumped or disturbed.

It should be noted that there are many more methods of attaching an ESL clip, strip, or ESL protector, to a shelf. The main purpose of the present invention is the addition of a gripper 10 to any ESL fixture so that indicia 14 is firmly displayed in gripper 10, and does not obscure the ESL 34.

For reference, the following numbers identify the following elements:
1—prior art ESL fixture attachment component
2—apparatus for retaining ESL on shelf front
4—shelf-engaging clip
6—lips for retaining ESL
8—ESL display socket
10—gripper
11—gripper joint
12—gripper fingers
14—indicia
16—shelf edge
18—shelf
20—products
22—apparatus for protecting shelf ESL
24—shelf-engaging portion of 22
26—ESL-covering portion of 22
28—holes in 24
30—holes in shelf
32—rivets
34—ESL
36—apparatus for protecting wire ESL
38—top portion of 36
40—rear lip of 36
42—front face of 36
44—bottom tongue of 36
45—wire basket
46—wire
48—peghook
50—peghook cross-brace
51—peghook flat mount
52—2 with wire-engaging clip
54—backing card
56—free-standing display
57—retaining lip of 56
58—glue-on apparatus
60—adhesive
62—slip-on apparatus
64—wings of slip-on apparatus
66—ESL-covering portion of slip-on apparatus

1. An apparatus for simultaneously exhibiting an Electronic Shelf Label (ESL) and a printed indicia on a retail store point of purchase display, wherein
said apparatus comprises an ESL-engaging portion,
said ESL-engaging portion comprises at least two lips to securely retain said ESL,
said apparatus comprising a connector to attach said apparatus to said retail store point of purchase display,
said apparatus comprises a gripper,
said gripper comprising at least one finger for frictional engagement with said indicia,
said gripper is adapted to jointly exhibit a printed indicia in concert with said ESL,
wherein said gripper facilitates quick and easy installation and removal of said printed indicia.

2. An apparatus for simultaneously exhibiting an Electronic Shelf Label (ESL) and printed indica according to claim 1, wherein said retail store point of purchase display is a shelf.

3. An apparatus for simultaneously exhibiting an Electronic Shelf Label (ESL) and printed indica according to claim 1, wherein said retail store point of purchase display is a wire grill.

4. An apparatus for simultaneously exhibiting an Electronic Shelf Label (ESL) and printed indica according to claim 1, wherein said retail store point of purchase display is a display backing card.

5. An apparatus for simultaneously exhibiting an Electronic Shelf Label (ESL) and printed indica according to claim 1, wherein said retail store point of purchase display is a peg hook.

6. An apparatus for simultaneously exhibiting an Electronic Shelf Label (ESL) and printed indica according to claim 1, wherein said apparatus is attached to a floor model.

7. An apparatus for simultaneously exhibiting an Electronic Shelf Label (ESL) and printed indica according to claim 1, wherein said apparatus is free-standing.

8. An apparatus for simultaneously exhibiting an Electronic Shelf Label (ESL) and printed indica according to claim 1, wherein said apparatus is made of extruded plastic, said gripper finger comprises a softer rubber-like material with a higher coefficient of friction than said apparatus, wherein said gripper finger is co-extruded with said apparatus.

9. An apparatus for simultaneously exhibiting an Electronic Shelf Label (ESL) and a printed indicia on a retail store point of purchase display, wherein
said apparatus comprises a sleeve with at least one opening, wherein said ESL is inserted into said sleeve through said opening,
said apparatus comprises an integrated gripper,
said gripper comprising at least one finger for frictional engagement with said indicia,
said integrated gripper adapted to jointly exhibit a printed indicia in concert with said ESL,
wherein said gripper facilitates quick and easy installation and removal of said indicia.

10. An apparatus for simultaneously exhibiting an Electronic Shelf Label (ESL) and printed indica according to claim 9, wherein said retail store point of purchase display is a shelf.

11. An apparatus for simultaneously exhibiting an Electronic Shelf Label (ESL) and printed indicia according to claim 9, wherein said retail store point of purchase display is a wire grill.

12. An apparatus for simultaneously exhibiting an Electronic Shelf Label (ESL) and printed indicia according to claim 9, wherein said retail store point of purchase display is a display backing card.

13. An apparatus for simultaneously exhibiting an Electronic Shelf Label (ESL) and printed indicia according to claim 9, wherein said retail store point of purchase display is a peg hook.

14. An apparatus for simultaneously exhibiting an Electronic Shelf Label (ESL) and printed indica according to claim 9, wherein said apparatus is attached to a floor model.

15. An apparatus for simultaneously exhibiting an Electronic Shelf Label (ESL) and printed indica according to claim 9, wherein said apparatus is free-standing.

16. An apparatus for simultaneously exhibiting an Electronic Shelf Label (ESL) and printed indicia according to claim 9, wherein said apparatus is made of extruded plastic, said gripper finger comprises a softer rubber-like material with a higher coefficient of friction than said apparatus, wherein said gripper finger is co-extruded with said apparatus.

17. An apparatus to simultaneously exhibit printed indicia and inhibit dislocation of an Electronic Shelf Label (ESL),
wherein said ESL is attached to a retail store point of purchase display,
said apparatus comprising a shield adapted to attach to said retail store point of purchase display to inhibit dislocation of said ESL,
said apparatus comprises an integrated gripper,
said gripper comprising at least one finger for frictional engagement with said indicia,
said integrated gripper adapted to cooperatively exhibit a printed indicia in concert with said ESL,
wherein said gripper facilitates quick and easy installation and removal of said indicia.

18. An apparatus to simultaneously exhibit printed indicia and inhibit dislocation of an Electronic Shelf Label (ESL) according to claim 17, wherein said retail store point of purchase display is a shelf.

19. An apparatus to simultaneously exhibit printed indicia and inhibit dislocation of an Electronic Shelf Label (ESL) according to claim 17, wherein said retail store point of purchase display is a wire grill.

20. An apparatus to simultaneously exhibit printed indicia and inhibit dislocation of an Electronic Shelf Label (ESL) according to claim 17, wherein said apparatus is made of extruded plastic, said gripper finger comprises a softer rubber-like material with a higher coefficient of friction than said apparatus, wherein said gripper finger is co-extruded with said apparatus.

21. An apparatus to simultaneously exhibit printed indicia and prevent damage of an Electronic Shelf Label (ESL),
wherein said ESL is attached to a retail store point of purchase display,
said apparatus comprising a casing adapted to attach to said ESL and retail store point of purchase display to prevent damage of said ESL,
said apparatus comprises an integrated gripper,
said gripper comprising at least one finger for frictional engagement with said indicia,
said integrated gripper adapted to cooperatively exhibit a printed indicia in concert with said ESL,
wherein said gripper facilitates quick and easy installation and removal of said indicia.

22. An apparatus to simultaneously exhibit printed indicia and prevent damage of an Electronic Shelf Label (ESL) according to claim 21, wherein said retail store point of purchase display is a peg hook.

23. An apparatus to simultaneously exhibit printed indicia and inhibit dislocation of an Electronic Shelf Label (ESL) according to claim 21, wherein said retail store point of purchase display is a wire grill.

24. An apparatus to simultaneously exhibit printed indicia and inhibit dislocation of an Electronic Shelf Label (ESL) according to claim 21, wherein said apparatus is made of extruded plastic, said gripper finger comprises a softer rubber-like material with a higher coefficient of friction than said apparatus, wherein said gripper finger is co-extruded with said apparatus.
